(19) United States
(12) Patent Application Publication
(10) Pub. No.: US 2013/0183934 A1
(43) Pub. Date: Jul. 18, 2013

(54) METHODS FOR INITIALIZING AND/OR ACTIVATING AT LEAST ONE USER ACCOUNT FOR CARRYING OUT A TRANSACTION, AS WELL AS TERMINAL DEVICE

(71) Applicant: VODAFONE HOLDING GMBH, Duesseldorf (DE)

(72) Inventors: Arno Roemer, Duesseldorf (DE); Erik Hengels, Korschenbroich (DE)

(73) Assignee: VODAFONE HOLDING GMBH, Duesseldorf (DE)

(21) Appl. No.: 13/628,453

(22) Filed: Sep. 27, 2012

(30) Foreign Application Priority Data
Sep. 27, 2011 (DE) 10 2011 115 154.4

(51) Int. Cl. H04W 12/08; H04L 9/08

(52) U.S. Cl. CPC H04W 12/08; H04L 9/0861
USPC 455/411; 380/44

(57) ABSTRACT

The present invention in particular relates to a method for initializing and/or activating at least one user account and/or a user identifier with at least one service provider by means of a first communications network, in particular a mobile network, whereby the user account and/or the user identifier has validity in at least one other second communications network that is independent of the first communications network. In order to be able to utilize transaction systems based on mobile networks, particularly in a simple and inexpensive manner also in situations outside the mobile sector, for example in WLAN via DSL situations, the method is characterized by the following steps: a) a request for initializing and/or activating the user account and/or the user identifier is generated by the user via a terminal device assigned to the first communications network and transmitted via a communication channel of the first communications network from the terminal device of the user to the service provider, in particular at least partially encrypted; b) during the transmission, an identifier characterizing the user and/or the terminal device of the user is assigned to the request on the part of the first communications network; c) after receiving the request with the added identifier, at least one user identifier that is independent of the communications network is generated on the part of the service provider; d) the generated user identifier is transmitted by the service provider to the terminal device of the user, in particular at least partially encrypted, and stored in this device.

The present invention first relates to a method for initializing and/or activating at least one user account and/or a user identifier with at least one service provider according to the preamble of patent claim 1. In addition, the invention relates to a method for carrying out a transaction between a terminal device assigned to a user and a service provider according to the preamble of patent claim 11. Finally, the invention also relates to a terminal device that is assigned to a first communications network, in particular a mobile network, and can also construct a communication connection to a second communications network that is different from the first communications network.

With increasing development of mobile terminal devices, such as, for example, mobile telephones, smart phones and the like, the bandwidth for possible applications thereof also increases. Therefore, it is already common practice at the present time that transactions of any type between the user of such a terminal device and a service provider can also be carried out by means of mobile telephones. In this case, it is imperative for the service provider to obtain validated information on the user who would like to carry out the transaction, since not infrequently payment processes are also involved in the transactions.

A solution is described in WO 2004/057547 A1, for example, in which a digital signature is stored in a mobile terminal device. The digital signature is encrypted and transmitted to the service provider. The service provider transmits the encrypted signature to the operator of the communications network to which the mobile terminal device is assigned. The network operator decrypts the signature and transmits the decrypted signature back to the service provider who thus can verify the user who would like to carry out the transaction. This method is complicated, however, since the involvement of the network operator is always required for each transaction.

It is described in GB 2 375 872 A that the user of a terminal device that is assigned to a mobile network signs for a transaction with a service provider by way of a digital signature. This signature can be stored in the mobile terminal device. After receiving the digital signature, the service provider can verify the user who requests the transaction by comparing the signature, for example, with certificates.

In the general prior art, it is also known that in mobile networks, data traffic is usually routed over computer devices, for example proxy computer devices, of the network operator. This makes it possible for the network operator to add an identifier for the user and/or the mobile terminal device, for example the MSISDN to transaction requests that a user directs to a service provider via his mobile terminal device that is assigned to the mobile network. The identifier in this case is an unambiguous identification means with which the service provider can identify the user requesting the transaction and/or the terminal device thereof.

At the present time, modern mobile terminal devices, for example smart phones and the like, are in a position to communicate, in addition to communication via the mobile network, also via a second communications network that is independent of the mobile network, for example by means of WLAN/LAN via DSL. In such cases, an identifier of the terminal device, for example the MSISDN, can no longer be added to a transaction request from the mobile network by the operator of the mobile network, since the above-named computer devices of the mobile network operator are no longer involved in a communication via WLAN, LAN via DSL. Therefore, the service provider can no longer identify the user and/or the terminal device of a user who would like to conduct a transaction.

Proceeding therefrom, the object of the present invention is to further develop methods of the type named initially as well as a terminal device of the type named initially in such a way that transaction systems based on mobile networks can also be utilized in a simple and uncomplicated way in situations outside the mobile sector, for example in WLAN via DSL situations or in DSL situations.

This object is achieved according to the invention by the method for initializing and/or activating at least one user account and/or a user identifier with at least one service provider with the features according to the independent patent claim 1, the method for carrying out a transaction between a terminal device assigned to a user and a service provider with the features according to the independent patent claim 11, as well as by the terminal device with the features according to the independent patent claim 15. Further features and details of the invention can be taken from the subclaims, the description and the drawings. Thus, features and details that are described in connection with one of the two method aspects, of course, also apply to the full extent in connection with the other method aspect in each case, and vice versa, so that reference is made alternatively to the full extent to the respective statements. Likewise, features and details that are described in connection with the two method aspects, of course, also apply to the full extent in connection with the terminal device according to the invention, and vice versa, so that here also reference is made alternatively to the full extent to the respective statements.

The basic concept of the present invention particularly consists in that at least one user identifier, preferably also a user account, is produced by means of a method on the part of a service provider that proceeds via a first communications network, for example a mobile network. This is transmitted on the terminal device of a user for whom the user identifier is specified and stored therein. The user identifier that involves an unambiguous means of identification of the user can also be used later when the user would like to conduct a transaction and communicates with a service provider via his terminal device via a second communications network that is independent from the first communications network. In particular, the user identifier is independent of the communications network. This particularly means that one and the same user identifier can thus be applied in different communications networks or for transactions that take place via different communications networks. That is, a generally valid user identifier exists that has validity for different communications networks. At least one of the communications networks, preferably both communications networks, may involve a telecommunications network, in particular.

A transaction particularly involves concluding a commercial transaction. For example, it may involve a transaction for concluding an electronic commercial transaction. The electronic commercial transaction can also be designated in particular as e-commerce or e-business.

A user account particularly involves a login to a service provider, in which the profile of the user is also stored. A user identifier is particularly an identification that makes it possible for the service provider to identify the user who possesses a user account with the service provider, in particular.

The present invention is not limited to specific applications in this case. It is preferably provided that a payment based on a SIM card is made possible by the present invention both in mobile networks as well as in WLAN/LAN/DSL situations, in particular WLAN/LAN via DSL situations. In particular, a possibility is created of how MSISDN-based payment systems can also be utilized in WLAN situations.

Essential fields of application of the present invention are, for example, services that offer their services, for example, payment methods, identity management and the like, to the retail customer who has internet access both via mobile communications such as GSM, UMTS, LTE and the like, as well as via WLAN, LAN, DSL and the like.

According to the first aspect of the present invention, a method is provided for initializing and/or activating at least one user account and/or a user identifier with at least one service provider by means of a first communications network, in particular a mobile network, the user account having validity in at least one other second communications network that is independent of the first communications network, wherein the method is characterized by the following steps:

a) a request for initializing and/or activating the user account and/or the user identifier is generated by the user via a terminal device assigned to the first communications network and transmitted via a communication connection, in particular a communication channel, of the first communications network, from the terminal device of the user to the service provider, in particular at least partially encrypted;

b) during the transmission, an identifier characterizing the user and/or the terminal device of the user is assigned to the request on the part of the first communications network;

c) after receiving the request with the added identifier, at least one user identifier that is independent of the communications network is generated on the part of the service provider;

d) the generated user identifier is transmitted by the service provider to the terminal device of the user, in particular at least partially encrypted, and stored in this device.

According to this first aspect of the present invention, a method is provided for initializing and/or activating at least one user account and/or a user identifier with at least one service provider. In this way, it is particularly provided that the user obtains or has a user account, also called an account, and/or a user identifier, for example a so-called account key with the provider, for example a service provider, a provider of goods or the like. Initializing particularly means that such a user account and/or such a user identifier is newly created with the service provider for the user. Activating particularly means that an already existing user account and/or an already existing user identifier is launched. It can be preferably provided that a user account initializing and/or a user identifier initializing can be initialized with a payment service provider.

In this case, a situation is involved that plays out in a first communications network. The method according to the first aspect of the invention is produced by means of a first communications network. The present invention is not limited to specific types of communications networks in this case. The first communications network preferably involves a telecommunications network, in particular a mobile network, e.g. according to the GSM, UMTS, LTE standard and the like, so that a mobile network situation is involved in such a case.

In addition, it is assured according to the invention that the user account and/or the user identifier that is initialized and/or activated in a situation that plays out in a first communications network has validity in at least one other second communications network that is independent from the first communications network. In this respect, reference is also made to the full extent to the general explanations for the user identifier given above. The second communications network may also involve, for example, a telecommunications network, e.g., according to the WLAN, LAN, DSL standard, in particular WLAN/LAN via DSL, and the like.

The following steps are provided for carrying out the method according to the invention:

A request for initializing and/or activating the user account and/or the user identifier is generated by the user via a terminal device assigned to the first communications network and transmitted via a communication connection of the first communications network, in particular via a communication channel of the first communications network, from the terminal device of the user to the service provider, in particular at least partially encrypted.

The terminal device particularly involves an electronic terminal device which is assigned to the first communications network, but which also makes possible a communication via the second communications network. It preferably involves a mobile terminal device. In the case of a mobile network as the first communications network, the terminal device can be designed, for example, as a mobile telephone, as a smart phone, as a notebook, as a tablet computer, and the like.

While the request from the terminal device of the user is transmitted to the service provider, an identifier characterizing the user and/or the terminal device of the user is assigned to the request on the part of the first communications network. The invention is not limited to specific types of identifiers in this case. Several advantageous, but non-exclusive examples will be explained in more detail in the further course of the description.

It can be preferably provided that the request generated in the terminal device of the user is transmitted to a computer device assigned to the first communications network, that in the computer device, the identifier characterizing the user and/or the terminal device of the user is assigned to the request, and that the request with the added identifier is transmitted from the computer device to the service provider. For example, the computer device may involve a server device. The server device may involve, for example, a PROXY, for example a type of intermediary in a computer network.

After the request with the added identifier has been transmitted to the service provider and has been received by the latter, at least one user identifier that is independent of the communications network is generated on the part of the service provider. The characteristics of such a user identifier that is independent of the communications network has been described in further detail above, so that here reference is made to the full extent to the corresponding statements given above. In another configuration, it may also be provided that a user account is generated on the part of the service provider, wherein the user identifier in this case represents a component of the user account. The user identifier may especially involve a type of customer number that is allocated by the service provider to the requesting user and/or the terminal device thereof.

It can preferably be provided that the request with the added identifier is transmitted to a computer device assigned to the service provider, that a user identifier is generated in the computer device of the service provider after receipt of the request with the added identifier, and that the user identifier is transmitted from the computer device of the service provider to the terminal device of the user, preferably via the computer device assigned to the first communications network, in particular via a communication connection of the first communications network. For example, the computer device of the service provider may involve a server device.

The generated user identifier is transmitted by the service provider to the terminal device of the user, in particular at least partially encrypted, and stored in this device. In this way, different sites where storage can be provided in the terminal device are possible. Several preferred, but nonexclusive examples are explained in more detail for this purpose in the further course of the description.

It is preferably provided that the first communications network is formed as a mobile network. In such a case, during the transmission, an MSISDN characterizing the user and/or the terminal device of the user is assigned to the request on the part of the first communications network. The operator of the mobile network thus complements the request with the MSISDN. One could also say that the MSISDN is injected into the request.

The present invention is not limited, however, to specific types of identifiers. Basically, an identifier may comprise any type of identification that can be assigned by other sites. The identifier must be of a type such that it makes possible an unambiguous identification of the electronic terminal device or user. In particular, the identifiers shall be configured so that they can be encrypted and decrypted. In particular, the identifiers also shall be configured so that they can be recognized and identified by the service provider. In connection with a mobile network, such an identifier can preferably involve an IMSI (International Mobile Subscriber Identity) and/or an MSISDN (Mobile Subscriber Integrated Services Digital Network Number). An IMSI particularly comprises 15 digits and represents the identification number of a mobile telephone. An MSISDN is particularly a unique call number assigned to a specific user that a caller selects in order to reach a mobile subscriber.

In the case of a mobile network as a first communications network, the continued existence of the MSISDN for identifying the retail customer is thus assured. In this way, in particular, all existing mobile services, independent of the access, can additionally be utilized.

Preferably, the user identifier is stored in a storage device assigned to the terminal device. In addition, data that are specific for the service provider may also be especially stored in the storage device. Such data may involve, for example, a service provider ID, the name of the service provider, a URL of the service provider, public keys of the service provider, and the like. In addition to this, private and public keys of the user may also be stored in this device.

Preferably, the user identifier can be stored in a user module assigned to the terminal device. In particular, a user module involves a module that serves for the identification of the user in the network. The user module particularly involves a region within the terminal device that is formed for the needs of the method according to the invention. In this case, the invention is not limited to specific types of user modules. It is preferably provided that the user module involves a SIM, a SIM application, a chip card application or a secure region in the terminal device.

In this case, the chip card application, for example, may be provided in the form of a chip card in the terminal device. In another configuration, it is also conceivable that the chip card application is implemented in the form of a software application in the electronic terminal device. Chip cards that are often also called a smart card or an integrated circuit card (ICC) in particular have an integrated circuit that may contain hardware logic, a storage device or even a microprocessor. It may preferably be provided that the user module involves a SIM application. A SIM (Subscriber Identity Module) particularly involves a chip card that is inserted into a mobile telephone and that serves for the identification of the user in the mobile network. With it, mobile service providers provide mobile telephone connections and data connections to subscribers.

Preferably, an MSISDN (Mobile Subscriber Integrated Services Digital Network Number) assigned to the user of the terminal device can be provided as the identifier.

The MSISDN is then assigned as the identifier to the request transmitted from the terminal device to the service provider.

For example, in this case, the user module may have a corresponding storage device. Such a storage device can preferably involve a storage device in which, as is further described above, the user identifier and optionally, data specific for the service provider are stored.

In addition, it is preferably a method in which the user module has an encrypting machine for encrypting and/or decrypting data and/or for generating keys for encrypting and/or decrypting data, in which at least portions of the request are encrypted and/or at least portions of the received user identification are decrypted and/or keys are generated in order to encrypt at least portions of the request and/or to decrypt at least portions of the received user identification by means of the encrypting machine, and/or in which the user module has a storage device in which data generated and/or received by the user module are stored at least temporarily. The storage device can preferably involve the storage device further described above.

Security is a particularly important aspect in the implementation according to the invention. It is preferably provided that the user module, for example, in the form of a SIM application, also carries out storage and encrypting of data. It is preferably provided that the user module has an encrypting machine, a storage device for storing data, an Administrations GUI (Graphical User Interface) and an interface to another application, which is described in more detail below.

For example, if the service offered by the service provider may involve a payment service, then the above-named components are particularly tailored or designed for carrying out payment procedures.

Preferably, the request for initializing and/or activating the user account and/or the user identifier will be transmitted to the service provider from an application assigned to the terminal device, whereby the user identifier generated by the service provider will be received by the application.

The application preferably communicates with the user module via an interface, whereby data from the user module are read out and/or stored in it via the interface from the application.

By the method according to this first aspect of the invention, the initializing and/or activating of the user account, for example the account and/or the user identifier, is provided by the first communications network, for example the mobile network. The use of the user account and/or the user identifier, however, also functions in a second communications network, for example in WLAN, DSL, LAN, particularly in WLAN/LAN via DSL situations, and the like. Each application implemented on the terminal device can utilize the generated user identifier. In this way, the method according to the invention is independent of carrier (carrier).

For clarification of this first aspect of the invention, it will be described in the following on the basis of an example.

By way of example, the service provider may involve a service provider on the internet who operates a web page, the web page being stored on a server device, a computer or the like, and being able to be contacted via the latter. The user of an electronic terminal device, for example a smart phone that is assigned to a mobile network, calls up the web page of the party via his electronic terminal device via the second communications network, for example the internet. Since the communication is not produced via the mobile network but rather via the internet, the identifier of the electronic terminal device in the first communications network, for example the MSISDN, is missing in the communication.

For this reason, a communication connection, for example a mobile connection, to the service provider is constructed in the first communications network when the user account and/or the user identifier is initialized/activated by the user via his electronic terminal device, whereby the corresponding MSISDN of the user is added by the operator of the mobile network to the request transmitted from the terminal device to the service provider.

The service provider thus receives an unambiguous identification of the user, can generate a user account and/or a user identifier based on this, and can send this back to the terminal device of the user. The user identifier will be stored therein.

If the user would now like to carry out a transaction with the service provider, which will be described below in connection with the second aspect of the invention, he can also do this via the second communications network, for example WLAN, DSL, LAN, particularly in WLAN/LAN via DSL situations, and the like, since the user identifier also has validity therefor.

According to the second aspect of the invention, a method is provided for carrying out a transaction between a terminal device assigned to a user and a service provider, whereby an application for carrying out transactions is implemented on the terminal device, whereby a communication relative to the transaction takes place between the terminal device and the service provider, in particular a computer device assigned to the service provider, via a communication connection in a communications network, whereby a transaction request is generated by the application in the terminal device and is transmitted to the service provider. This method is characterized according to the invention in that the application for generation of the transaction request accesses a user module assigned to the terminal device; in that a service provider for which a user identifier is present is selected by the application from a storage device that is assigned to a user module and that has service providers available for the transaction as well as corresponding user identifiers for the user with these service providers that are independent of the communications network; in that the application reads out the user identifier for the service provider from the storage device assigned to the user module; in that the user identifier in the application is added to the transaction request; in that the transaction request with the added user identifier is transmitted by the application of the terminal device to the service provider; in that the user identifier is verified on the part of the service provider; and in that upon successful verification, the transaction is carried out.

Relative to the individual method components as well as their configuration and mode of operation, reference is also made to the full extent to the above statements for the first aspect of the method according to the invention.

With this method, a transaction can be carried out between a terminal device assigned to a user and a service provider. A transaction particularly involves concluding a commercial transaction, as further explained above. For example, it may involve a transaction for concluding an electronic commercial transaction. A transaction particularly involves a service exchange between the user and the service provider. For example, the transaction may include a transfer of goods and/or information between the user and the service provider. In this case, it can also be provided that the transaction represents or comprises a payment process.

In order to be able to carry out the method, an application for carrying out transactions, in particular between the user and the service provider, is implemented on the terminal device of the user.

Between the terminal device and the service provider, in particular a computer device assigned to the service provider, a communication relative to the transaction takes place via a communication connection in a communications network, in particular the internet via WLAN, LAN, DSL, especially in WLAN/LAN via DSL situations, and the like.

To this end, a transaction request is generated by the application in the terminal device and is transmitted to the service provider.

It is provided according to the invention that the application for the generation of the transaction request is accessed on a user module assigned to the terminal device; for example, via a suitable interface between application and user module.

The user module can preferably involve a user module described further above with respect to the first aspect of the invention, in particular a SIM or a SIM application or a chip card application or a secure region in the terminal device, so that reference is made to the full extent to the corresponding statements given above.

A service provider for whom a user identifier is present is selected by the application or via the application from a storage device that is assigned to the user module and that has service providers available for the transaction as well as corresponding user identifiers for the user with these service providers. The user identifier particularly involves a user identifier that is independent of the communications network. One and the same user identifier can thus be applied in different communications networks or for transactions that take place via different communications networks. That is, a generally valid user identifier exists that has validity for different communications networks. In this respect, reference is also made to the full extent to the general explanations for the user identifier that is independent of the communications network.

The application reads out the user identifier of the service provider from the storage device assigned to the user module. For example, it can be provided that the application implemented on the terminal device reads out the user identifier, for example a user account key—a so-called Account Key—from a user module designed as a SIM application.

In the application, this user identifier is added to the transaction request. In addition, it can be provided that at least components of the transaction request and the user identifier are encrypted in a suitable way, for which reason an encryption machine that is preferably implemented in the user module is employed.

The transaction request with the added user identifier is subsequently transmitted by the application of the terminal device or by the terminal device to the service provider.

The user identifier is verified on the part of the service provider. Upon successful verification, the transaction is carried out.

The service provider, for example a payment service provider—a so-called Payment Provider—is requested with the user identifier. Therefore an addition, e.g., of an identifier from a first communications network, e.g., an MSISDN, is no longer necessary, since the user identifier is an unambiguous identification means; it does not matter whether the transaction takes place via a first communications network, for example a mobile network, or, however, via a second communications network, for example WLAN, LAN, DSL, in particular in WLAN/LAN via DSL situations, or the like.

Independent of the communications network utilized, a service-specific user identifier, for example in the form of a cookie, can be stored in the user module, for example on a SIM, which identifies the user on the service level, for example in connection with a payment service. Likewise, it does not matter how the user accesses the internet with his terminal device, whether via the mobile network or a second communications network that is different from this, such as WLAN, LAN, DSL, or the like. The user is always identified and above all identified securely by the remote site, for example a payment service.

After a transaction has taken place, preferably a status report can be sent form the service provider to the application of the terminal device or the terminal device.

Preferably, the user module can have an encryption machine for encrypting and/or decrypting data and/or for generating keys for encrypting and/or decrypting data, whereby at least portions of the transaction request are encrypted and/or at least portions of the received data of the service provider are decrypted by means of the encryption machine. The encryption machine can preferably involve an encryption machine as described further above with respect to the first aspect of the invention, so that reference is made to the full extent to the corresponding statements given above.

In addition, a method is preferred, in which the service providers available for the transaction as well as corresponding user identifiers for the user with these service providers will be or are pre-set in the storage device of the terminal device, and/or in which service providers available for the transaction as well as corresponding user identifiers for the user with these service providers are generated by means of a method according to the invention as described above according to the first aspect of the invention, and are stored in the storage device. Reference is made to the full extent to the above statements relating to the first aspect of the invention.

According to a third aspect of the present invention, a terminal device is provided, which is assigned to a first communications network, in particular a mobile network and can construct a communication connection also to a second communications network, which is different than the first communications network, in particular a WLAN/LAN/DSL network, in particular a WLAN/LAN via DSL network, the device having a user module with a storage device, in which service providers available for transactions as well as corresponding user identifiers for the user with these service providers that are independent of the communications network are stored, an application for initializing and/or activating at least one user account for at least one service provider and/or for carrying out a transaction between the terminal device and a service provider, an interface for exchanging data between the user module and the application, as well as an interface for exchanging data between the terminal device, in particular the application, and a service provider, particularly a computer device assigned to a service provider.

The terminal device in particular has means for carrying out the method according to the first and second aspects of the invention, so that reference is made to the full extent to the corresponding statements on the two method aspects relative to the configuration and mode of operation of the terminal device.

A basic feature of the present invention, as it is described based on the three aspects of the invention, consists of the fact that the user identifier for the user with a service provider is stored in the user module, for example the SIM application, in the terminal device of the user. Another feature represents an application which is implemented on the terminal device and which accesses the user module via an interface.

Upon the first contact of the user with the service provider, at least one user identifier, also optionally a user account, is set up on the part of the service provider. For this purpose, the communication between the user or the terminal device of the user and the service provider takes place via a first communications network, for example a mobile network. In this way, an identifier for the user, for example his MSISDN, is added to the request through the operator of the first communications network.

The user module can now store and, as needed, also encrypt the different service providers, the user identifiers, and optionally also further information specific to the service provider.

The invention will now be explained in more detail on the basis of embodiment examples with reference to the appended drawings. Here:

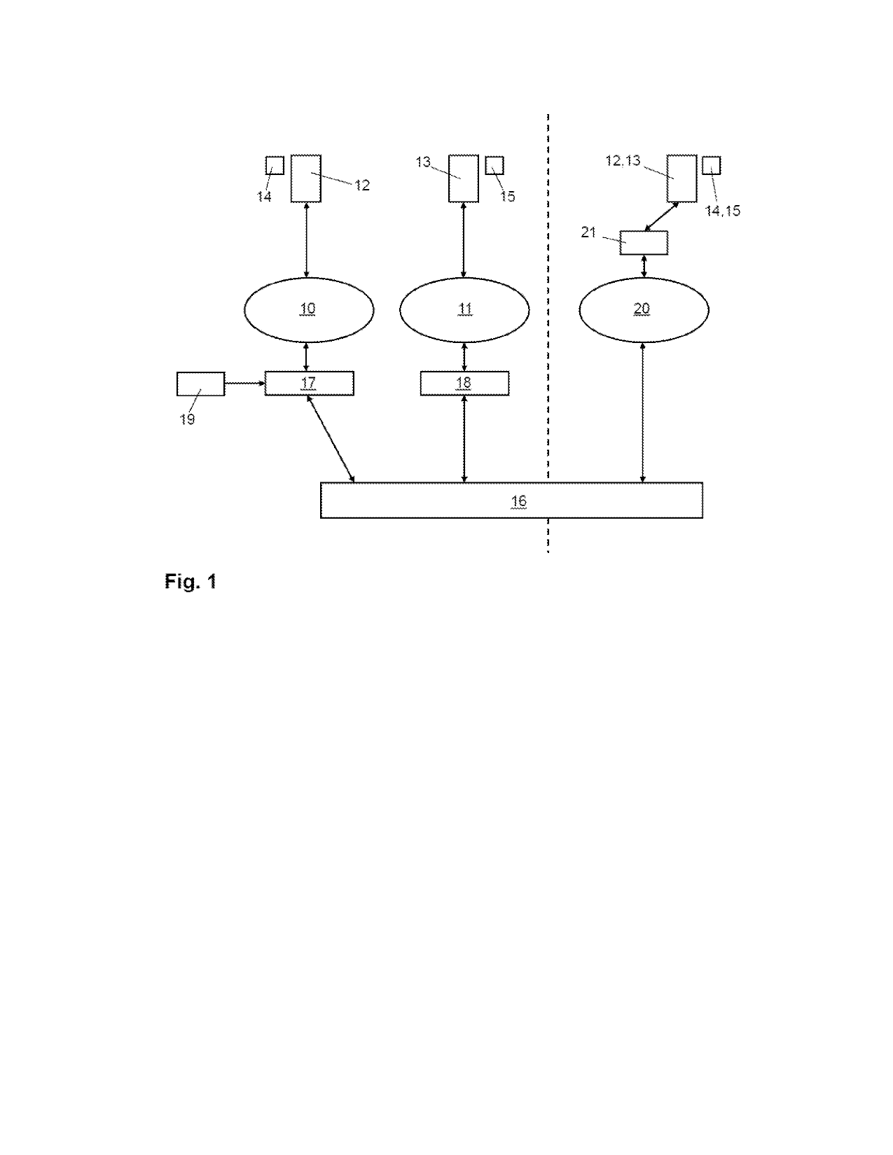

FIG. 1 shows in a schematic view the starting point of the present invention, which is known from the prior art;

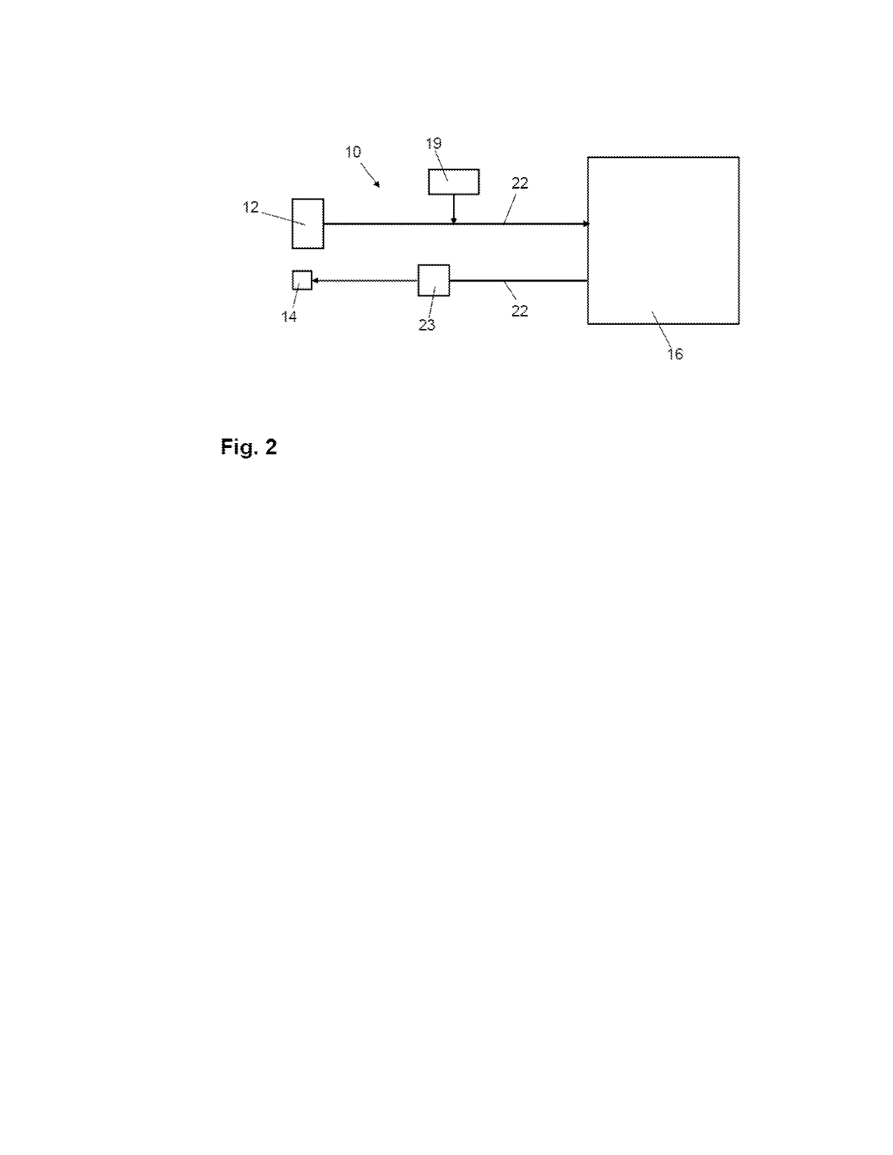

FIG. 2 shows in general schematic representation how an initializing and/or activating of a user account and/or a user identifier for a service provider takes place;

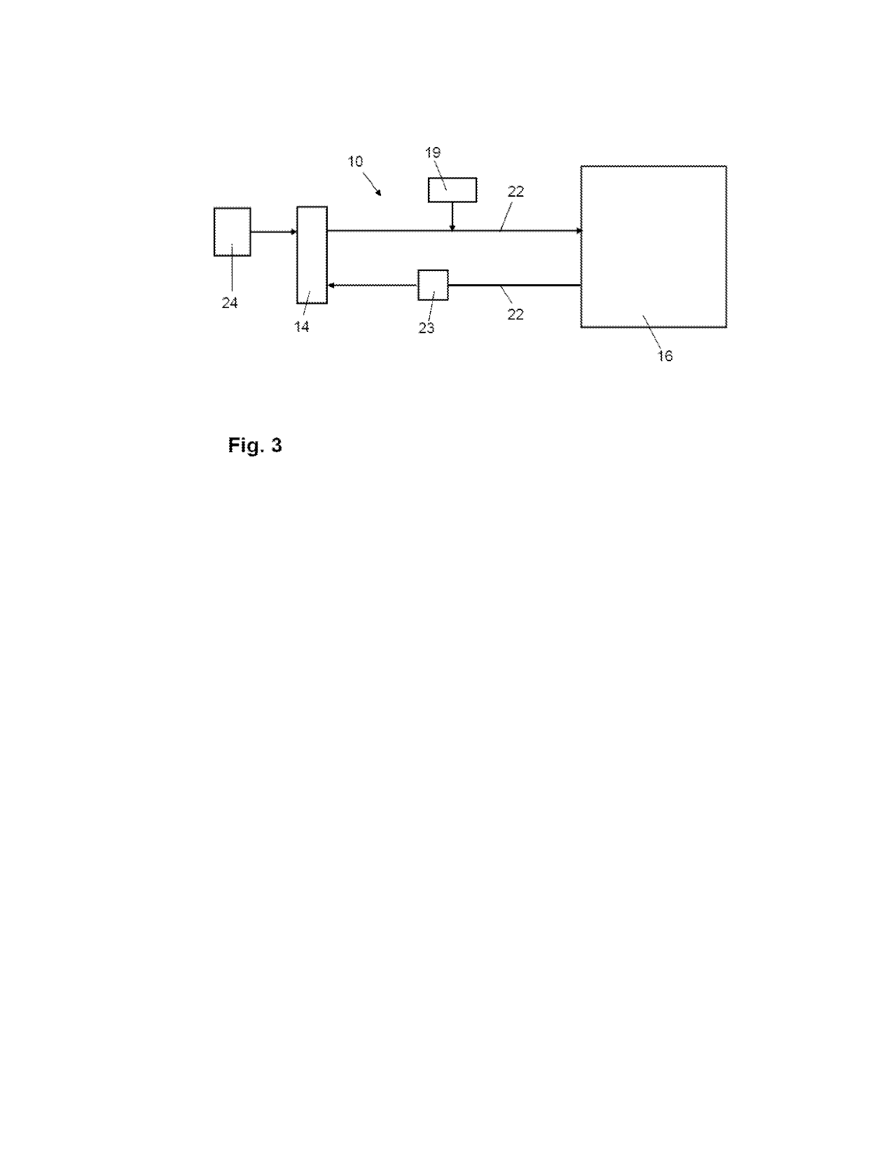

FIG. 3 shows the schematic representation based on FIG. 2, from which the flow of the encryption keys is visible;

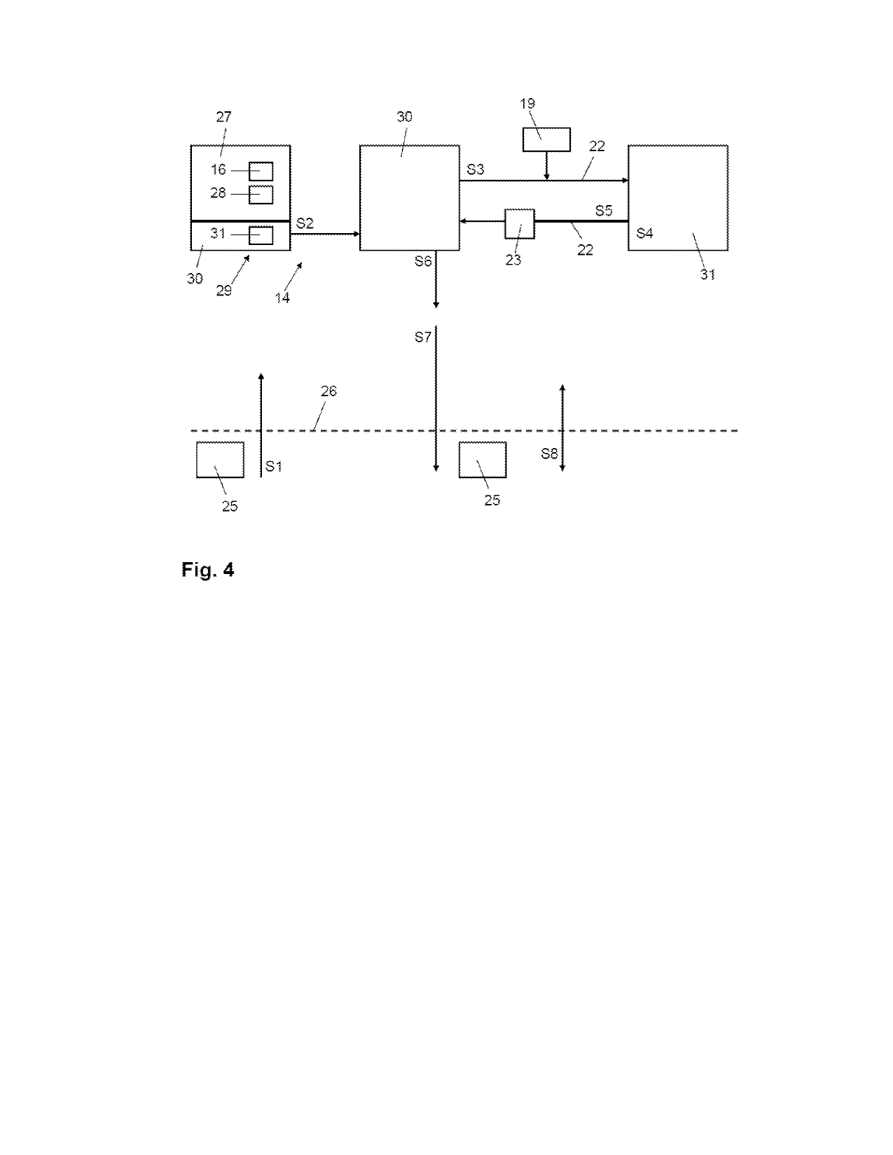

FIG. 4 shows an example of embodiment in which a new service provider is initialized on the terminal device of a user;

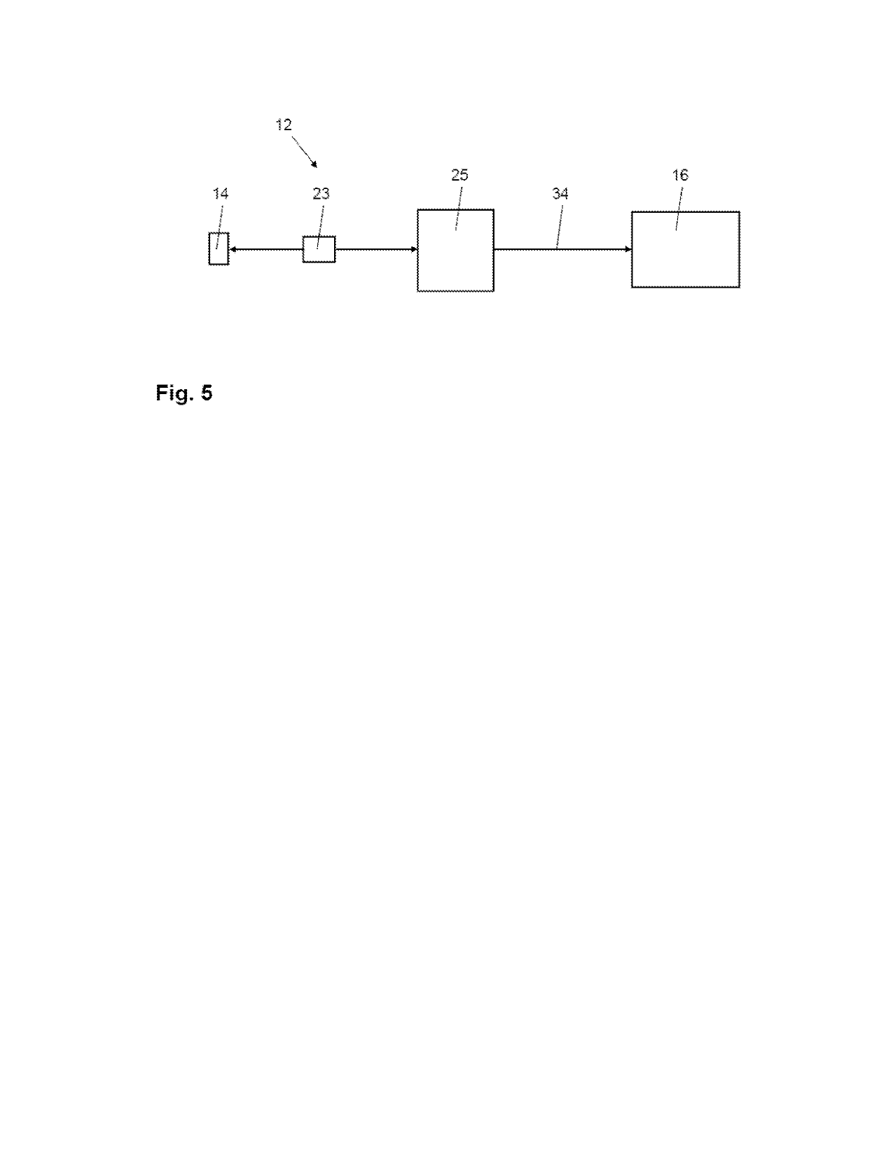

FIG. 5 shows in general schematic representation how a method for carrying out a transaction between a user and a service provider is carried out;

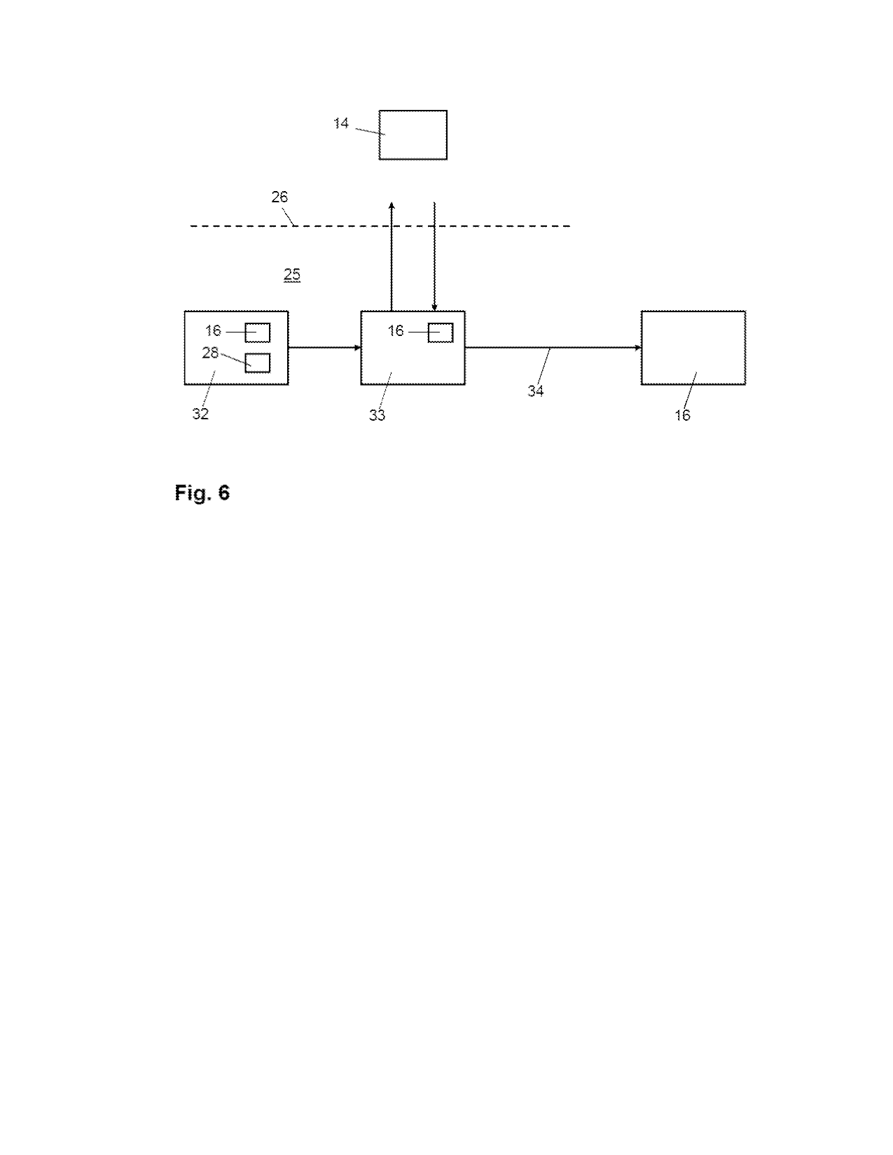

FIG. 6 shows in schematic representation a method for carrying out a transaction between a user and a service provider from the view of an application implemented in a terminal device; and

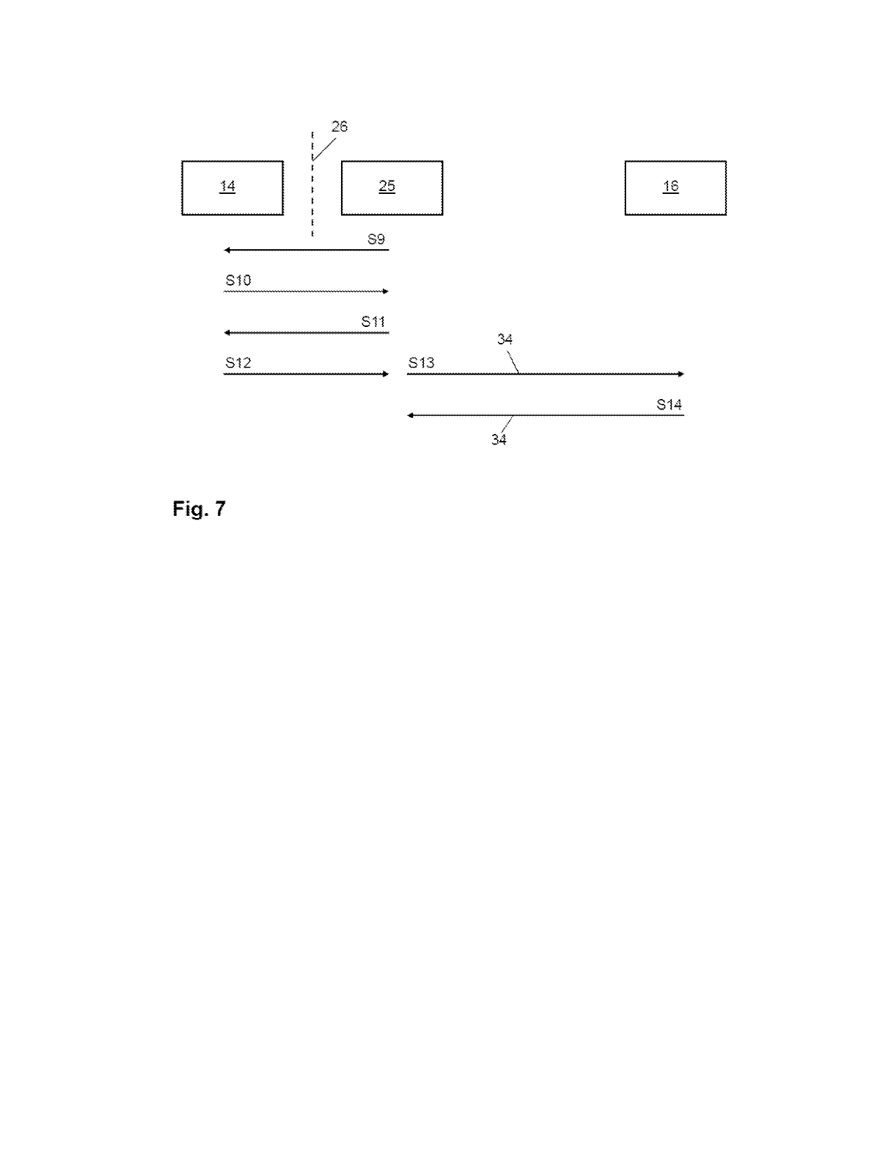

FIG. 7 shows the schematic representation based on FIGS. 5 and 6, from which the flow of encryption keys is visible.

A situation is shown in FIG. 1 as it is known presently from the prior art and which serves as the starting point for the present invention.

On the left part of FIG. 1, two different first communications networks 10, 11 are shown, which involve mobile networks. In mobile networks, the data traffic is usually routed via a proxy server of the network operator. To each first communications network 10, 11 is assigned a terminal device 12, 13, which involves, for example, a mobile telephone. Each terminal device 12, 13 provides a user module 14, 15, for example in the form of a SIM application.

If, by means of his terminal device 12, 13, a user communicates with a service provider 16, for example a payment service provider, via the first communications network 10, 11, and sends a request for a transaction, for example a payment process to service provider 16, the data traffic is routed via a computer device 17, 18 of the network operation, for example a proxy server. In this way, it is made possible for the operator of the first communications network 10, 11 to add an identifier 19, for example an MSISDN of the user, to the request directed to service provider 16 from terminal device 12, 13 of the user. This identifier 19 in this case is an unambiguous possible identification of the user with service provider 16.

In WLAN via DSL situations, which are shown on the right part of FIG. 1, the user communicates via his terminal device 12, 13 via a second communications network 20 that is different from the first communications network, for example via the internet, whereby the communication can take place in particular via a router 21, for example a WLAN/DSL router. The proxy servers 17, 18 of the operator of the first communications networks 10, 11 are not involved in such WLAN via DSL situations. The identifier 19, for example the MSISDN, consequently cannot be injected into the request by the network operator. For this reason, service provider 16 cannot identify the user in this way. In particular, it is not possible in this way to use MSISDN-based payment systems in WLAN via DSL situations.

This can now be achieved by the present invention. It is particularly possible with the present invention to be able to utilize mobile network-based payment functions even in situations outside the mobile network, for example in WLAN via DSL situations.

It is generally schematically shown in FIG. 2 how an initializing and/or activating of a user account and/or a user identifier with a service provider 16 can take place. In this case, the initializing and/or activating with the service provider 16 takes place by means of a first communications network 10, in particular a mobile network, whereby the user account and/or the user identifier will have validity in at least one other second communications network that is independent of the first communications network. It thus involves a situation in the first communications network. Via his terminal device 12, for example a mobile telephone, which has a user module 14, for example a SIM application, the user transmits a corresponding request to the service provider 16, which takes place via a communication channel 22 assigned to the first communications network 10. In this case, the operator of the first communications network 10 can add an identifier 19, clearly identifying the user, for example the MSISDN, and thus inject it in the request correspondingly. After receiving the request, the service provider 16 generates a user identifier 23, for example a so-called Account Key, optionally also a user account, whereby the user identifier 23 is a component of the user account. The user identifier 23 is sent to the terminal device 12 of the user via a communication connection, for example the communication channel 22 of the first communications network 10, and is stored in the user module 14. In addition, information for identifier 19 or identifier 19 itself, for example information for the MSISDN or the MSISDN, can also be stored in the user module.

A view based on FIG. 2 is shown in FIG. 3, from which the flow of encryption keys is visible. In this case, the initializing and/or activating of the user account and/or the user identifier with service provider 16 in turn takes place by means of a first communications network 10, in particular a mobile network, whereby the user account will have validity in at least one other second communications network that is independent of the first communications network. It thus involves a situation in the first communications network. The user module 14 of the terminal device, which involves a SIM application, receives “over the air (OTA)” 24 the URL, the name and the public key of service provider 16, whereby specific data for this service provider are stored in user module 14. Pairs of keys for each service provider, namely the public and private keys of the user, will be generated also in user module 14. A request will be transmitted from user module 14 to service provider 16, which takes place via a communication channel 22 assigned to the first communications network 10. The request may comprise registration data and the public key of the user, whereby these data may be encrypted with the public key of the service provider. For example, it may also be provided that an application which transmits the request is implemented in the terminal device of the user. In this case, the application reads out the necessary data from user module 14 via an interface. Here, the operator of the first communications network 10 can add an identifier 19, clearly identifying the user, for example the MSISDN, to the request and thus inject it in the request correspondingly. After receiving the request, the service provider 16 generates a user identifier 23, for example a so-called Account Key, optionally also a user account, whereby the user identifier 23 is a component of the user account. For this purpose, the data received are decrypted on the part of service provider 16 with the private key of service provider 16. A user account is created for the received identifier and the received registration data. In addition, the private key of the user is stored and a user identifier 23 is generated. The user identifier 23 is encrypted with the public key of the user and sent to the terminal device of the user via a communication channel, for example communication channel 22 of the first communications network 10. The information containing the private key of the user, which is received from service provider 16, will be decrypted in user module 14, and the user identifier will be stored in user module 14.

An example of embodiment is shown in FIG. 4, in which a new service provider is implemented on the terminal device of a user. Via an application 25, which is implemented in the terminal device of the user, the latter can access the internet, for example, and request services of different service providers. In this case, if the user finds the services of a service provider, for which he as yet has no user account and no user identifier, application 25 accesses a user module 14 provided in the terminal device in a method step S1 via an interface 26, which may involve an API, for example; the user module can be designed as a SIM application, for example. In this way, application 25 initiates an administrations GUI 29 for service providers. A storage device 27 in which several service providers 16, 28 with corresponding user identifiers for the user and other information specific to the service providers have already been created is accessed via user module 14. These will be displayed on the administrations GUI 29 for service providers. In addition, a region for the input of additional service providers 30 is provided on the administrations GUI 29 for service providers.

In a method step S2, the region for inputting additional service providers 30 is activated, and registration data are generated. Involved here, for example, are the names of the user, the login of the user, the password of the user and the bank connection data of the user.

In a further method step S3, the registration data and the public key for the user of user module 14 are transmitted to a new service provider 31, which takes place via a communication channel 22 assigned to the first communications network. In this case, the operator of the first communications network can add an identifier 19, clearly identifying the user, for example the MSISDN, and thus inject the data correspondingly. After receiving the data, in a method step S4, the service provider 31 generates a user identifier 23, for example a so-called Account Key, optionally also a user account, whereby the user identifier 23 in this case is a component of the user account. For this purpose, the data received are decrypted with the private key of service provider 31 on the part of service provider 31. A user account is created for the received identifier 19 and the received registration data. In addition, the public key of the user is stored and a user identifier 23 is generated. The user identifier 23 is encrypted with the public key of the user and sent to the terminal device of the user via a communication channel, for example communication channel 22 of the first communications network 10, in a method step S5, and placed in user module 14, whereby the public key of service provider 31 is also transmitted with it simultaneously. In a method step S6, the information containing the private key of the user, which is received from service provider 31, will be decrypted and validated in user module 14, and the user identifier or the user account will be stored in user module 14. The new service provider 31 is now activated, which is illustrated by the dashes shown.

In a method step S7, the user module 14 is closed and it is returned to application 25. The desired, newly created service provider 31 can now be selected via interface 26 in a method step S8, since a user identifier for the user is now available for this provider.

A general schematic representation of how a method for carrying out a transaction between a user and a service provider 16 is carried out is shown in FIG. 5. A terminal device 12, which has a user module 14, for example a SIM application 14 and an application 25 for carrying out transactions, is assigned to the user. The application 25 reads out the user identifier 23 from the user module. In this case, it is particularly provided that the user identifier is independent of the communications network. After this, the application transmits a request, for example a payment request with the user identifier to the service provider 16, for example a payment service provider. This is done, for example, via a communication channel 34 of a second communications network, for example a WLAN/LAN via DSL network. In this case, adding an identifier, for example an MSISDN, is no longer necessary, since the user identifier according to a method that is shown and described in FIGS. 1 to 4 has been previously generated and thus represents an unambiguous identification means. In this case, it does not matter whether the terminal device 12 of the user communicates with the service provider 16 via a first communications network, for example a mobile network, or a second communications network that is different from the first communications network, for example a WLAN, LAN or DSL situation, in particular a WLAN/LAN via DSL situation. The user identifier that was created in connection with the first communications network also has validity in the second communications network.

A method for carrying out a transaction between a user and a service provider 16 is shown in FIG. 6, the method being described from a view of an application 25 that is implemented in the terminal device, whereby application 25 communicates via an interface 26 with a user module 14, for example a SIM with a SIM application, also provided in the terminal device.

Application 25 has a list 32 containing different service providers 16, 28. Application 25 matches list 32 with a list 33, which contains preferred service providers, wherein service provider 16 is matched, for example. Application 25 now communicates with user module 14 via interface 26, in order to read out the necessary data, for example the user identifier 23, which is formed as a user identifier that is independent of the communications network, for the user with service provider 16, and to encrypt different data. A request from application 25 is sent to service provider 16 via a communication channel 34 of a second communications network, wherein the request contains transaction data and the network identifier of the user with service provider 16, whereby at least individual parts of the data, in particular the user identifier, are encrypted.

Finally, a schematic representation based on FIGS. 5 and 6, from which the flow of encryption keys is visible, is shown in FIG. 7. In turn, the communication between application 25, user module 14 and service provider 16 is shown.

Application 25 accesses user module 14 via interface 26 in a method step S9. In a method step S10, the user module sends back to application 25 a list of user identifiers that are encrypted with the public key of the respective service provider. The user subsequently selects via application 25 a suitable service provider, service provider 16 in the present example. Then in a method step S11, the transaction data generated by application 25 are transmitted via interface 26 to user module 14 and encrypted therein. The encrypted transaction data that were encrypted with the public key of service provider 16 are transmitted back from user module 14 to application 25 in a method step S12. A transaction request will be generated therein. The transaction request, the URL of service provider 16, and the transaction data will be transmitted to service provider 16 via a communication channel 34 of the second communications network in a method step S13, all data being encrypted with the public key of service provider 16. Service provider 16 decrypts the data with the private key of service provider 16. The transaction will be carried out and the status of the transaction will be sent back in the form of a status report from service provider 16 to application 25 via communication channel 34 in a method step S14.

### LIST OF REFERENCE CHARACTERS

10 First communications network (mobile network)

11 First communications network (mobile network)

12 Terminal device (mobile telephone)

13 Terminal device (mobile telephone)

14 User module (SIM application)

15 User module (SIM application)

16 Service provider

17 Computer device (proxy server)

18 Computer device (proxy server)

19 Identifier

20 Second communications network (internet)

21 Router (WLAN/DSL router)

22 Communication channel assigned to the first communications network

23 User identifier

24 “Over the air (OTA)” receiving

25 Application

26 Interface

27 Storage device

28 Service provider

29 Administrations GUI of service providers

30 Region for inputting additional service providers

31 Service provider

32 List containing service providers

33 List containing preferred service providers

34 Communication channel of the second communications network

S1 Method step

S2 Method step

S3 Method step

S4 Method step

S5 Method step

S6 Method step

S7 Method step

S8 Method step

S9 Method step

S10 Method step

S11 Method step

S12 Method step

S13 Method step

S14 Method step

1. A method for initializing and/or activating at least one user account and/or a user identifier with at least one service provider by means of a first communications network, in particular a mobile network, whereby the user account and/or the user identifier has validity in at least one other second communications network that is independent of the first communications network,
characterized by the following steps:
a) a request for initializing and/or activating the user account and/or the user identifier is generated by the user via a terminal device assigned to the first communications network and transmitted via a communication channel of the first communications network from the terminal device of the user to the service provider, in particular at least partially encrypted;
b) during the transmission, an identifier characterizing the user and/or the terminal device of the user is assigned to the request on the part of the first communications network;
c) after receiving the request and the added identifier, at least one user identifier that is independent of the communications network is generated on the part of the service provider;
d) the generated user identifier is transmitted from the service provider to the terminal device of the user, in particular at least partially encrypted, and stored in this device.

2. The method according to claim 1, further characterized in that the request generated in the terminal device of the user is transmitted to a computer device assigned to the first communications network, in that in the computer device, the identifier characterizing the user and/or the terminal device of the user is assigned to the request, and in that the request complemented by the identifier is transmitted from the computer device to the service provider.

3. The method according to claim 1, further characterized in that the request with the added identifier is transmitted to a computer device assigned to the service provider, in that a user identifier is generated in the computer device of the service provider after receiving the request with the added identifier, and in that the user identifier is transmitted from the computer device of the service provider to the terminal device of the user, preferably via the computer device assigned to the first communications network, in particular via a communication channel of the first communications network.

4. The method according to claim 1, further characterized in that the first communications network is formed as a mobile network and in that during the transmission, an MSISDN characterizing the user and/or the terminal device of the user is assigned to the request on the part of the first communications network.

5. The method according to claim 1, further characterized in that the user identifier is stored in a storage device assigned to the terminal device and in that data that are specific for the service provider are also stored particularly in the storage device.

6. The method according to claim 1, further characterized in that the user identifier is stored in a user module, in particular a SIM or a SIM application or a chip card application or a secure region in the terminal device, which is assigned to the terminal device.

7. The method according to claim 6, further characterized in that the user module has an encryption machine for encrypting and/or decrypting data and/or for generating keys for encrypting and/or decrypting data, and in that at least portions of the request are encrypted and/or at least portions of the received user identifier are decrypted and/or keys are generated in order to encrypt at least portions of the request and/or to decrypt at least portions of the received user identifier by means of the encrypting machine, and/or in that the user module has a storage device in which data generated and/or received by the user module are stored at least temporarily.

8. The method according to claim 1, further characterized in that the request for initializing and/or activating the user account and/or the user identifier will be transmitted to the service provider by an application assigned to the terminal device, and in that the user identifier generated by the service provider will be received by the application.

9. The method according to claim 6, further characterized in that the request for initializing and/or activating the user account and/or the user identifier will be transmitted to the service provider by an application assigned to the terminal device, and in that the user identifier generated by the service provider will be received by application.

10. The method according to claim 9, further characterized in that the application communicates with the user module via an interface and reads out data from the user module and/or stores data in it.

11. A method for carrying out a transaction between a terminal device assigned to a user and a service provider, whereby an application for carrying out transactions is implemented on the terminal device, whereby a communication relative to the transaction takes place between the terminal device and the service provider, in particular a computer device assigned to the service provider, via a communication channel in a communications network, whereby a transaction request is generated by the application in the terminal device and is transmitted to the service provider, hereby characterized
in that, for generating the transaction request, the application accesses a user module assigned to the terminal device;
in that, a service provider, for which a user identifier exists, is selected by the application from a storage device that is assigned to the user module, the storage device containing the service providers available for the transaction as well as corresponding user identifiers for the user with these service providers that are independent of the communications network;
in that the application reads out the user identifier of the service provider from the storage device assigned to the user module,
in that the user identifier is added in the application to the transaction request;
in that the transaction request with the added user identifier is transmitted by the application of the terminal device to the service provider;
in that the user identifier is verified on the part of the service provider; and
in that upon successful verification, the transaction is carried out.

12. The method according to claim 11, further characterized in that the user module is a SIM or a SIM application or a chip card application or a secure storage device in the terminal device.

13. The method according to claim 11, further characterized in that the user module has an encryption machine for encrypting and/or decrypting data and/or for generating keys for encrypting and/or decrypting data, and in that at least portions of the transaction request are encrypted and/or at least portions of the received data of the service provider are decrypted by means of the encryption machine.

14. The method according to claim 11, further characterized in that the service providers available for the transaction as well as corresponding user identifiers for the user with these service providers will be pre-set in a storage device, and/or in that the service providers available for the transaction as well as corresponding user identifiers for the user with these service providers will be generated by means of a method according to claim 1 and stored in the storage device.

15. A terminal device, which is assigned to a first communications network, in particular a mobile network, and which can also construct a communication connection to a second communications network, different from the first communications network, the device having a user module with a storage device, in which service providers available for transactions as well as corresponding user identifiers for the user with these service providers that are independent of the communications network are stored, an application for initializing and/or activating at least one user account for at least one service provider and/or for carrying out a transaction between the terminal device and a service provider, an interface for exchanging data between the user module and the application, as well as an interface for exchanging data between the terminal device, in particular the application, and a service provider, in particular a computer device assigned to a service provider.

16. The terminal device according to claim 15, further characterized in that it has means for carrying out the method according to one of claim 1 or 11.
